(19) United States
(12) Patent Application Publication
(10) Pub. No.: US 2018/0209486 A1
(43) Pub. Date: Jul. 26, 2018

(54) DRIVELINE CLUTCH MODULE

(71) Applicant: GKN Automotive Ltd., Redditch, Worcestershire (GB)

(72) Inventors: Jan Haupt, Kürten (DE); Mortiz Abbenhaus, Troisdorf (DE)

(21) Appl. No.: 15/744,862

(22) PCT Filed: Jul. 8, 2016
(86) PCT No.: PCT/EP2016/066324

§ 371 Date: Jan. 15, 2018

(30) Foreign Application Priority Data
Jul. 24, 2015 (DE) 102015112102.6

(51) Int. Cl. F16D 11/10; F16D 3/223; F16D 27/00; F16D 23/14; F16H 48/08; F16H 48/24; F16H 57/037; F16H 57/025

(52) U.S. Cl. CPC F16D 11/10; F16D 3/223; F16D 27/00; F16D 23/14; F16D 2023/141; F16H 48/24; F16H 57/037; F16H 57/025; F16D 2003/22326; F16H 48/08

(57) ABSTRACT

A clutch module for a powertrain of a motor vehicle, comprises a clutch housing with connection elements; a drive shaft which is rotatably mounted in the clutch housing about a rotational axis by means of a shaft bearing, wherein an outer end portion of the drive shaft lies outside of the clutch housing, and an inner end portion of the drive shaft lies within the clutch housing; a constant velocity joint, a joint outer part of the constant velocity joint being arranged as least partly within the clutch housing and being rotatably mounted in the clutch housing about the rotational axis by means of a joint bearing; and a controllable clutch which is arrange din the clutch housing and which is designed to optionally separate or connect the drive shaft and the joint outer part in order to transmit a torque. A drive assembly can comprise such a clutch module.

### CROSS-REFERENCE TO RELATED APPLICATIONS

This application is a national stage of, and claims priority to, Patent Cooperation Treaty Application No. PCT/EP2016/066324, filed on Jul. 8, 2016, which application claims priority to German Application No. DE 10 2015 112 102.6, filed on Jul. 24, 2015, which applications are each hereby incorporated herein by reference in their entireties.

### DESCRIPTION

The present disclosure relates to a clutch module, in particular for the driveline of a motor vehicle. By means of such a clutch module, torque can be selectively transmitted to a driving axle of a motor vehicle or a transmission of torque can be interrupted.

From U.S. Pat. No. 6,634,978 B2 a differential assembly is known having a differential mechanism and a switching mechanism which are accommodated in a common housing. The differential mechanism comprises a differential carrier, a plurality of differential gears and two sideshaft gears. The first sideshaft gear is connected in a rotationally fixed way to a first constant velocity joint for driving a first sideshaft. The second sideshaft gear comprises outer splines, and an inner bearing bore in which a joint journal of a second constant velocity joint is rotatably supported. The joint journal comprises an outer toothed portion on which a hub is supported in a rotationally fixed way. The switching mechanism comprises a sliding muff which is displaceably arranged on the hub for connecting the hub to the second sideshaft gear or disconnecting same therefrom.

DE 103 12 348 A1 proposes a differential gearing with an integrated locking clutch to be used as an axle gearing in a selectively drivable drive axle of a motor vehicle having a plurality of drive axles. The locking clutch is arranged to be effective between a first sideshaft gear of the differential gearing and an associated first sideshaft. The locking clutch which is configured as a viscous clutch or a controllable multi-plate clutch comprises a clutch cage which is welded to an intermediate shaft and a clutch hub which is integrally connected to an outer joint part.

From US 2010/0094519 A1 a driveline of a motor vehicle is known, comprising a permanently driven front axle and an optionally drivable rear axle. The distribution of torque between the front axle and the rear axle is effected by a transfer case having a friction plate clutch that can be controlled by an electronic control unit. In order to avoid friction losses due to unnecessary rotation of the downstream drive portion when the friction plate clutch is open, the rear axle is provided with a disconnect device in the form of a form-locking clutch. The form-locking clutch is arranged in a split sideshaft of the rear axle so as to adjoin the rear axle differential.

U.S. Pat. No. 4,625,584 B proposes a similar drive assembly with a split driving axle that is connectable via a clutch mechanism to transmit torque or is disconnectable to interrupt the transmission of torque.

From DE 10 2009 037 428 A1 an axle shaft disconnect assembly is known with a differential gearing and a clutch assembly. The differential gearing comprises two sideshaft gears that are each connected to an associated hollow shaft in a rotationally fixed way. A shaft journal of an outer joint part passes through the hollow shaft and is rotatable relative to the hollow shaft. A clutch assembly is provided between the hollow shaft and the shaft journal, the clutch having a clutch muff that is axially displaceable by a fluid-operated clutch setting member.

DE 10 2012 022 011 A1 proposes a drive assembly for a driveline of a motor vehicle, which drive assembly comprises a transmitting element and a constant velocity joint. The outer joint part of the constant velocity joint is axially displaceable relative to the transmitting element by a sliding muff. A loose ring is provided adjacent to the ball tracks of the outer joint part, which loose ring is freely rotatable in the outer joint part via bearing elements. Depending on the sliding position of the outer joint part, the balls of the joint selectively engage the ball tracks of the outer joint part or are located in the lose ring, so that they do not transmit any torque between the outer joint part and the inner joint part.

From DE 10 2005 004 290 A1 a transmission module is known for variably transmitting torque in the driveline of a motor vehicle. The transmission module comprises two shafts, a transmission stage with a plurality of planetary gears arranged therebetween and a planetary carrier as well as a clutch for coupling the carrier element relative to a stationary housing.

It is the object of the present invention to propose a clutch module, in particular for a driveline of a motor vehicle, that is compact and easy to mount. The objective is further to propose a drive assembly into which a respective clutch module can easily be integrated.

A solution proposes a clutch module, in particular for a driveline of a motor vehicle, comprising: a clutch housing that comprises connecting elements for connecting to a transmission housing; a driveshaft that is rotatably supported in the clutch housing around a rotational axis by a shaft bearing, wherein an outer end portion of the driveshaft is arranged outside the clutch housing and an inner end portion of the driveshaft is arranged inside the clutch housing; a constant velocity joint having an outer joint part, an inner joint part and torque transmitting elements that are arranged between the outer joint part and the inner joint part for transmitting torque, wherein the outer joint part is at least partially arranged inside the clutch housing and is rotatably supported in the clutch housing around the rotational axis by a joint bearing; and a controllable clutch that is arranged in the clutch housing and configured to optionally drivingly connect or disconnect the driveshaft and the outer joint part.

An advantage is that the clutch module forms a separate structural unit and can easily be connected to a transmission that is configured to be separate from the clutch module, so that easy mounting conditions are achieved. In this context, a structural unit is understood to be a pre-assembled, operable unit with captive parts. The engineering effort for adapting the transmission for being connected to the clutch module is small. The clutch housing encloses an inner chamber in which the clutch is arranged. The clutch is configured to connect the end portion of the driveshaft to the outer joint part for transmitting torque, or to disconnect same therefrom. The driveshaft extends from the interior of the housing outwardly through a housing portion in which the shaft is rotatably supported. At the outer end portion, the driveshaft comprises means for introducing torque, for instance splines for being connected to a transmission drive part.

The clutch module is easy to handle as a pre-assembled structural unit and, via defined interfaces, can be easily connected to the transmission. For this purpose, the driveshaft of the clutch module can be connected via a plug-in connection to an output element of the transmission for transmitting torque. The plug-in connection can comprise in particular shaft splines at the outer end portion of the driveshaft which are inserted into corresponding splines of the transmission in a rotationally fixed way. Subsequently, the clutch housing and the transmission housing can be connected to one another via the connecting means. The connecting means can comprise common form-fitting and/or force-fitting connectors such as threaded connectors for example and/or material-locking connection such as welded connections.

A further advantage is that the clutch module can be used variably for different applications. For example the clutch module can be connected to a transmission, wherein it is possible to arrange the module in the power path in front of the transmission, so that the transmission is optionally driveable by the upstream driveline or disconnectable, or to arrange module in the power path behind the transmission, so that the downstream driveline can optionally be driven or disconnected. According to a possible embodiment, the transmission can be a differential gearing, in particular an axle differential of the motor vehicle. The clutch module can be arranged subsequent the axle differential and in this case serves for drivingly connecting and disconnecting a sideshaft. It is understood that other applications are also possible, for instance the clutch module can also be connected to a central differential of a multi-axle driven motor vehicle for optionally driving an associated axle or switching it so as to be torque-free, or the clutch module can be connected to a power take-off unit.

According to a possible embodiment, the clutch can be configured as a form-locking clutch. Form-locking clutches means clutches wherein the transmission of torque is effected by the form-fitting engagement of at least two clutch parts. For example, form-fitting clutches can be claw clutches or toothed clutches. By closing the clutch it is achieved that the driveshaft and the constant velocity joint rotate jointly, wherein in the open condition of the clutch they rotate freely relative to one another. It is understood however that the clutch can generally also have a different configuration, for instance in the form of a friction clutch or multi-plate clutch.

The clutch can comprise a first clutch part that is connected to the inner end portion of the driveshaft, a second clutch part, that is connected to the outer joint part, as well as an axially movable coupling element for drivingly connecting the first clutch part with the second clutch part. The first clutch part can be configured to be integral with the shaft journal and, in particular, can comprise first form-fitting elements. Alternative or in addition, the second clutch part can be configured to be integral with the outer joint part and, in particular, can comprise second form-fitting elements.

The coupling part can be moved into a first position in which the driveshaft is connected to the outer joint part for transmitting torque, and into a second position in which the driveshaft and the outer joint part are freely rotatable relative to each other. The coupling part can be configured in the form of a sliding muff, for example, which engages one of the first and the second clutch part in a rotationally fixed way and which, by being displaced axially, can be made to engage the other one of the first and the second clutch part.

According to an embodiment, the first form-fitting elements and the second form-fitting elements are configured to be identical, i.e., the coupling part can comprise unitary engaging means for being form-fittingly connected to the driveshaft and the outer joint part. The first and the second clutch part and/or the first and the second form-fitting elements can each comprise a greatest outer diameter which is greater than the pitch circle diameter of the torque transmitting elements of the constant velocity joint. Thus, the clutch parts and, respectively, the form-locking elements are arranged on a relatively large diameter, so that the axial structural size of the clutch module is particularly small. To ensure an easy assembly it is possible that a greatest head diameter of the second form-fitting elements is smaller than the inner bearing seat diameter of the joint bearing.

According to an embodiment, an actuator is provided for operating the clutch, respectively for displacing the coupling element. The actuator can be configured in the form of an electro-magnetic actuator, for example, with the displacement of the coupling element being effected by magnetic forces. An electro-magnetic actuator is advantageous in that it comprises a compact size and a simple technical configuration. More particularly, the actuator can comprise an axially movable piston rod, wherein a shift-fork is provided that is fixed to the piston rod and engages an annular groove of the coupling element to transmit an axial movement of the piston rod to the coupling element.

According to an embodiment, the clutch housing can comprise a centering portion for centering the clutch housing relative to the transmission housing, wherein the centering portion is arranged in particular in an axial region of overlap with the shaft bearing. The centering portion simplifies assembly of the clutch module to the transmission and ensures that the driveshaft is axially aligned coaxially to a rotational axis of the transmission. The centering portion can comprise a centering face that is slid into or onto a corresponding counter face of the transmission, so that the two housings are coaxially aligned relative to each other.

The joint outer part and the driveshaft are each supported rotatably in the clutch housing. In addition, a radial bearing can be provided between the outer joint part and the driveshaft, by which bearing the outer joint part and the shaft journal are rotatably supported relative to one another. For sealing the clutch housing at the joint end, a joint sealing ring can be sealingly arranged between an outer face of the outer joint part and an inner face of the clutch housing, which sealing ring seals the clutch housing towards the outside. The joint sealing ring can be arranged so as to axially overlap with the outer ball tracks and/or the cavity of the outer joint part.

According to an embodiment, the clutch housing is composed of several parts that are connected to one another. In particular the clutch housing can comprise a joint bearing portion in which the joint bearing is arranged, wherein a smallest aperture diameter of the joint bearing portion is greater than a greatest outer diameter of the outer joint part. Furthermore, the clutch housing can comprise a shaft bearing portion in which the shaft bearing is arranged, wherein a smallest aperture diameter of the shaft bearing portion is smaller than a greater outer diameter of the driveshaft. The two housing portions are connected to one another after the components accommodated therein have been mounted, in particular by a flange connection that for instance can be welded or threaded. The closed housing comprises a wall portion and/or a side wall through which the driveshaft passes, as well as an opposed wall portion and/or side wall through which the constant velocity joint passes. The outer end portion of the shaft is configured to provide a rotationally fixed connection with a drive component. The constant velocity joint can be connected to a side shaft in a rotationally fixed way.

The outer joint part comprises a cavity which receives the inner joint part, wherein the cavity at least partially axially overlaps with the joint bearing and/or with the joint bearing portion of the clutch housing. Thus, the constant velocity joint projects relatively far into the clutch housing, so that the axial size of the clutch module overall is short. It can be proposed that the greatest axial length of the outer joint part is shorter than the greatest axial length of the driveshaft, which also contributes to a short axial length of the clutch module.

Furthermore, a solution is provided by a drive assembly with a differential gearing and a clutch module which is configured according to one or several of the above-mentioned embodiments, wherein the differential gearing comprises a gearing housing, a differential carrier which is supported in the gearing housing so as to be rotatable around the rotational axis (A) and is rotatingly drivable by a drive gear, as well as a differential gear set with two output gears, wherein the clutch housing of the clutch module is connected to the gearing housing of the differential gearing by the connecting elements, wherein the outer end portion of the driveshaft is connected in a rotationally fixed way to one of the two output gears of the differential gearing.

The disclosed and claimed drive assembly substantially provides the same advantages as described in connection with the disclosed and claimed clutch module, to which reference is hereby made. In particular, the clutch module, as a pre-mounted structural unit, can easily be connected to the differential gearing. For this purpose a defined interface is provided at which the two units are firmly connected to one another by suitable connecting means. To ensure that the two units are precisely aligned relative to one another, a centering assembly can be provided by which the clutch housing and the transmission housing are centered relative to each other. The centering assembly is configured in particular such that the rotational axis of the differential carrier and the rotational axis of the driveshaft are aligned coaxially relative to one another. For this purpose, the centering assembly can comprise, for example, a centering portion associated with the transmission housing and a centering portion associated with the clutch housing which are inserted into each other with a suitable fit. The contact faces of the centering portions can also be outwardly sealed via a sealing ring. The connection of the two housings can be effected by flange connections or threaded connections, for example.

Preferred embodiments will be explained below with reference to the drawings, wherein

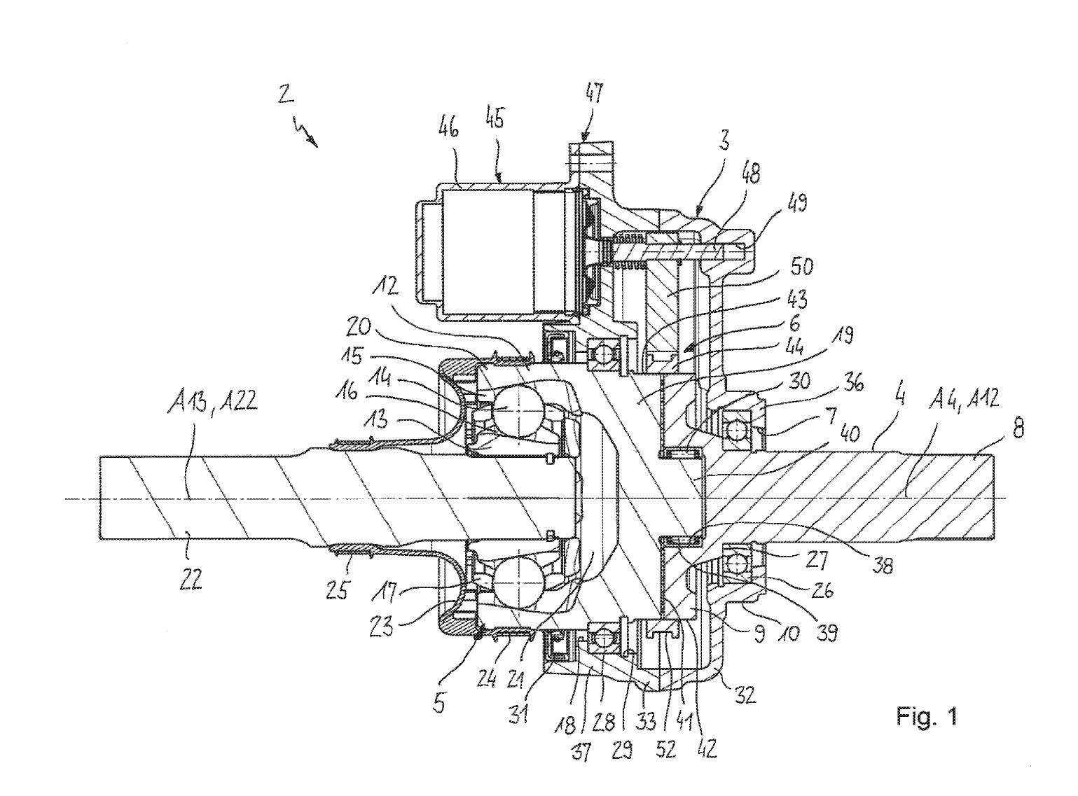

FIG. 1 shows an exemplary clutch module in a longitudinal section, with the clutch being in a closed position;

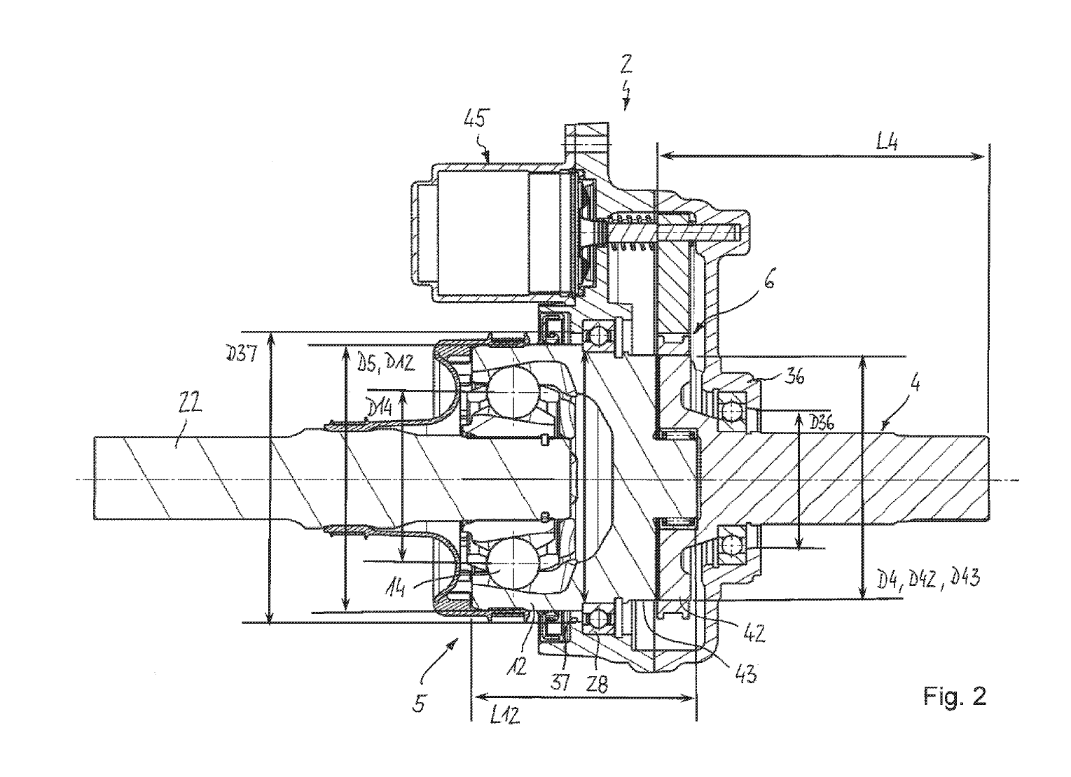

FIG. 2 shows the clutch module according to FIG. 1 with the clutch being in an open position;

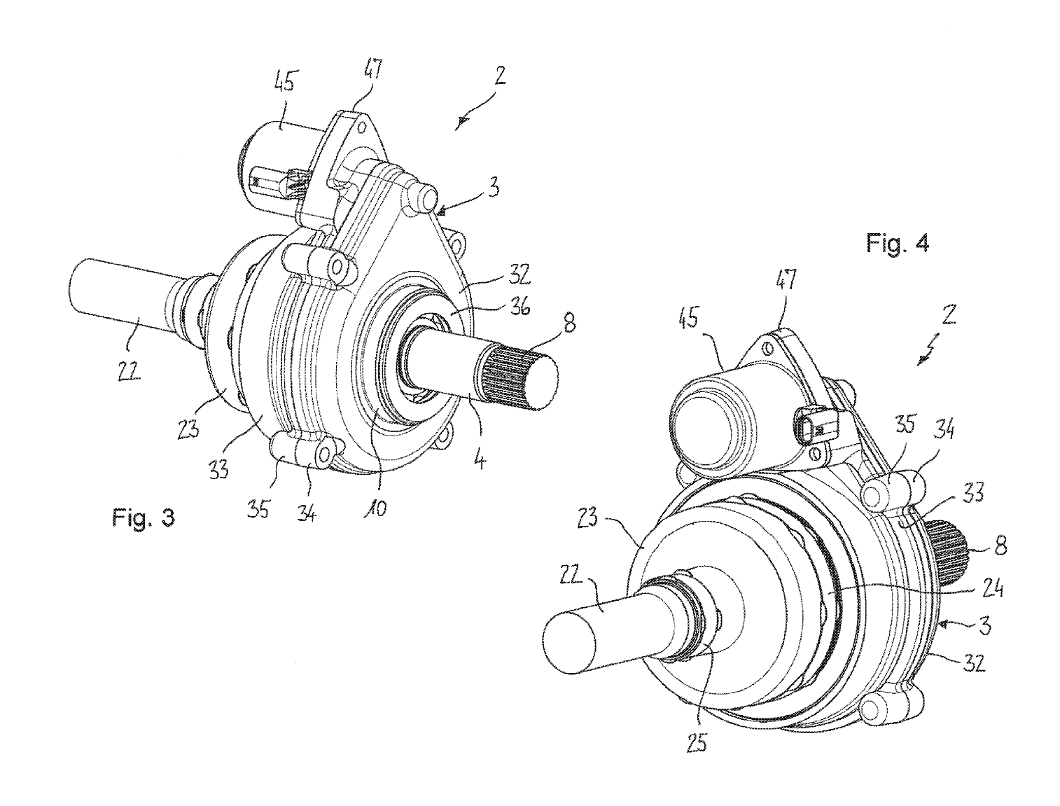

FIG. 3 shows the clutch module according to FIG. 1 in a first perspective view onto the shaft end;

FIG. 4 shows the clutch module according to FIG. 1 in a second perspective view onto the joint end;

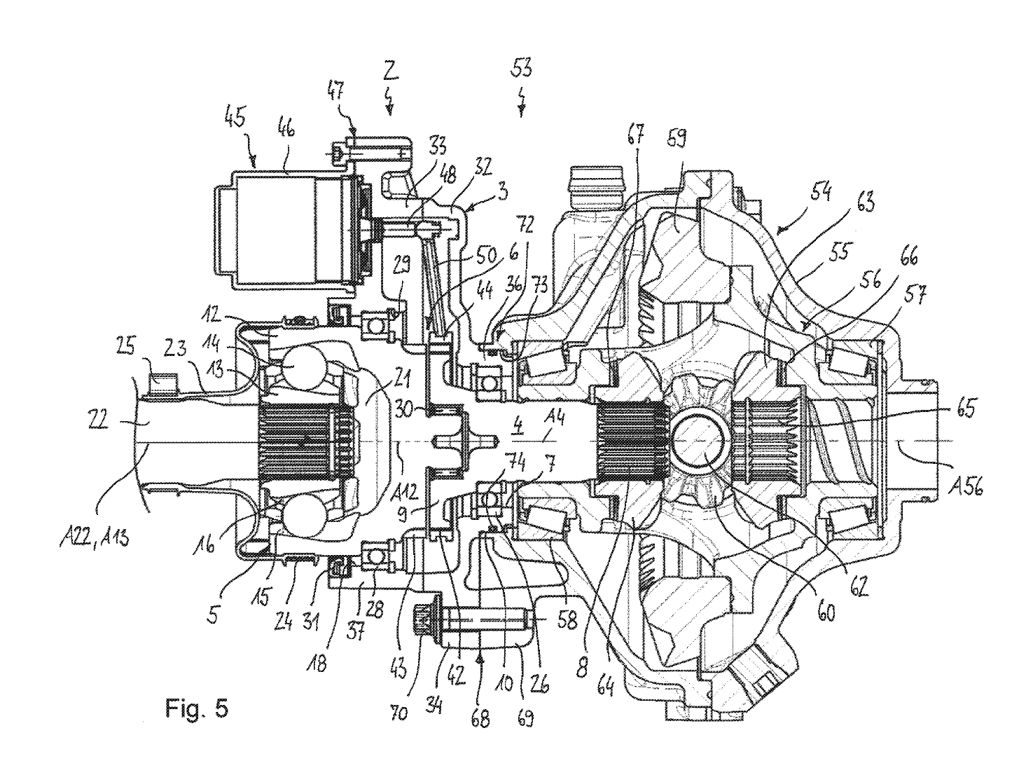

FIG. 5 shows an example drive assembly having an example clutch module according to FIG. 1 and a differential gearing in a longitudinal section.

FIGS. 1 to 4 which will be described jointly, show an exemplary clutch module 2. A clutch module 2 can be used in the driveline of a motor vehicle for selectively controlling the transmission of power from a drive source, for example an internal combustion engine or an electric motor, to a driven drive axle and/or within a drive axle. For this purpose, the clutch module 2 can be arranged within the driveline between the drive source and the vehicle wheels in order to, depending on the requirements, permit or interrupt a transmission of torque from the drive source to the drive axle arranged downstream in the power path. In this case, the clutch module can be generally arranged in any place in the selectively drivable driveline and, in particular, can be connected to a transmission unit, for example to a transfer case, a central differential and/or an axle differential.

The clutch module 2 comprises a clutch housing 3, a rotatingly drivable driveshaft 4, a constant velocity joint 5 which can be coupled to the driveshaft 4, and a controllable clutch 6 for drivingly connecting the driveshaft 4 to the constant velocity 5.

The clutch housing 3 encloses a cavity in which the clutch is arranged. The driveshaft 4 extends through an aperture 7 in a wall portion of the clutch housing 3, so that an outer end portion 8 of the driveshaft 4 is arranged outside the clutch housing 3 and an inner end portion 9 of the driveshaft 4 is arranged inside the clutch housing 3. The outer end portion 8 of the driveshaft 4 comprises engaging means for introducing a torque from a drive component, which engaging means can be configured for example in the form of shaft splines or a spline profile. The second end portion 9 positioned in the clutch housing 3 can be connected to the constant velocity joint 5 by a controllable clutch 6, if required.

The constant velocity joint 5 comprises an outer joint part 12, an inner joint part 13 and torque transmitting elements 14 that are arranged between the outer joint part and the inner joint part for transmitting torque. The outer joint part 12 comprises a plurality of circumferentially distributed outer ball tracks 15 and the inner joint part 13 comprises a plurality of circumferentially distributed inner ball tracks 16, with an outer and an inner ball track respectively being arranged radially opposite to one another and jointly accommodate a torque transmitting element 14. It can be seen that, in the present embodiment, the constant velocity joint 5 is configured in the form of a constant velocity ball joint. The torque transmitting elements 14, accordingly, are provided in the form of balls which are received in circumferentially distributed windows of a ball cage 17 arranged between the outer joint part 12 and the inner joint part 13. It is understood that, as an alternative to the constant velocity ball joint shown here as a fixed-type joint, also any other type of joint is possible, for example a constant velocity universal joint of the plunging type or a tripod joint.

The outer joint part 12 extends through a corresponding opening 18 in the clutch housing 3, so that a first portion 19 of the outer joint part 12 is arranged inside the clutch housing 3 and a second portion 20 of the outer joint part 5 is arranged outside the clutch housing 3. In this regard, the terms “inside” and “outside” refer to the clutch housing 2 in the axial direction. By means of the clutch 6, the outer joint part 12 can optionally be connected to the second end portion 9 of the driveshaft 4 for torque transmitting purposes or it can be uncoupled from same. The inner joint part 13 is angularly movable relative to the outer joint part 12 and is connected in a rotationally fixed way to a driveshaft 22 which, for example, can form part of a sideshaft for driving a vehicle wheel.

A sealing element 23 is provided between the outer joint part 12 and the driveshaft 22, which seals the joint cavity towards the outside. A larger first collar of the sealing element 23 is connected to the outer joint part 12 by a tensioning strip 24, and a smaller second collar is connected to the driveshaft 22 by a second tensioning strip 25. The sealing element 23 is provided in the form of a rolling boot, wherein it is understood that any other type of sealing element can also be used, for instance a convoluted or a membrane boot.

The driveshaft 4, which can also be referred to as an input shaft, and the outer joint part 12 are arranged coaxially relative to one another, i.e. the rotational axes A4, A12 coincide. The inner joint part 13 is angularly movable relative to the outer joint part 12, and in an angled position, the two rotational axes A12, A13 enclose an articulation angle. The driveshaft 4 is rotatably supported around the rotational axis A4 by a shaft bearing 26 and is axially supported via a supporting face 27. The outer joint part 12 is rotatingly supported around the rotational axis A12 via a joint bearing 28. The outer joint part 12 is axially supported in both axial directions via the joint bearing 28 at the clutch housing 3. For axial securing purposes, axial securing rings are inserted into corresponding annular grooves 29. The two bearings 26, 28 are configured as rolling contact bearings, in particular as ball bearings, wherein it is understood that other types of bearings can also be used, for example bevel roller bearings or friction bearings.

The clutch housing 3 is configured in particular in two parts and, at the shaft side, comprises a first housing part 32 in which the driveshaft 4 is rotatably supported and, at the joint side, a second housing part 33 in which the outer joint part 12 is rotatably supported. The two housing parts 32, 33 are connected to one another after the assembly of the components to be received therein. The two housing parts 32, 33 comprise corresponding connecting elements 34, 35 by which the two housing parts 32, 33 can be connected to one another and, respectively to a connecting part for instance a transmission housing. In the present embodiment, the connecting elements 34, 35 comprise several circumferentially distributed flange portions that correspond to one another and can be fixed by threaded pins to one another and, respectively, to a stationary connecting part. It is understood that other types of connecting means are also possible, for instance a welded connection. For aligning the clutch module 2 relative to the stationary connecting part, the clutch housing 3, at the housing part 32 at the shaft side, comprises a cylindrical centering face 10 that interacts with a corresponding counter face of the connecting part, so that the clutch module 2 and the connecting part are centered relative to one another.

The housing part 32 at the shaft side comprises a bearing portion 36, and/or a side wall with a bearing portion 36, in which the shaft bearing 26 is accommodated. The end portion 9 arranged in the clutch housing 3 is flange-shaped and comprises a greater diameter D4 than the shaft portion projecting from the housing 3. It is proposed that the smallest aperture diameter D36 of the bearing portion 36 is smaller than the greatest outer diameter D4 of the driveshaft 4. For mounting purposes, the driveshaft 4 with the first end portion 8 is introduced from the inside through the aperture 7. The housing part 32 at the joint side comprises a bearing portion 37 and/or a side wall with the bearing portion 37 in which the joint bearing 28 is accommodated. It can be seen that the joint bearing portion 37 comprises a smallest aperture diameter D37 which is greater than a greatest outer diameter D12 of the housing part 12. A sealing ring 31 is sealingly arranged between an outer face of the outer joint part 12 and an inner face of the clutch housing 3 for sealing the clutch housing 3 towards the joint.

In addition to supporting the driveshaft 4 and the outer joint part 12 in the stationary clutch housing 3, the two parts 4, 12 are supported by a further bearing 30 so as to be rotatable relative to one another. For this purpose, the driveshaft 4 and the outer joint part 12, at their end portions facing one another, comprise a bearing seat 38, 39 between which the bearing 30 is accommodated. The bearing 30 is configured as a needle bearing, wherein however other bearing types such as a friction bearing can also be used. The bearing seat 38 of the driveshaft 4 is formed by an end recess into which an end journal 40 of the outer joint part 12 is inserted. It is understood that a kinematic reversal is also possible, i.e. that the driveshaft comprises a journal which is inserted into a recess of the outer joint part. An axial gap 41 is formed between the end face of the driveshaft 4 and the opposed end face of the outer joint part 12, i.e., the driveshaft 4 and the outer joint part 12, overall, are contactless relative to one another.

The outer joint part 12 comprises a cavity 21 in which the inner joint part 13 is accommodated. It can be seen that the cavity 21 partially overlaps with the joint bearing 28 and/or with the bearing portion 37 of the clutch housing 3, so that the constant velocity joint 3 projects relatively far into the clutch housing 3. The greatest axial length L12 of the outer joint part 12 is smaller than the greatest axial length L4 of the driveshaft 4, so that the axial length of the clutch module is overall small.

The rotatingly drivable driveshaft 4 and the outer joint part 12 can be drivingly coupled to one another, or uncoupled, by the clutch 6. In the present embodiment, the clutch 6 is configured as a form-fitting clutch and comprises a first clutch part 42 with first form-fitting elements that are formed at the end portion 9 of the driveshaft 4, a second clutch part 43 with second form-fitting elements that are formed at the outer joint part 12, as well as an axially movable coupling element 44 for connecting the first and the second form-fitting elements in a rotationally fixed way. The coupling part 44 can be moved into a first position in which the driveshaft 4 and the outer joint part 12 are connected to one another to transmit torque, and into a second position in which the driveshaft 4 and the outer joint part 12 are freely rotatable relative to one another. The first position, which can also be referred to as the closed position, is shown in FIG. 1, whereas the second position, which can also be referred to as the open position, is shown in FIG. 2. The coupling element 44 is configured as a sliding muff which engages the form-fitting elements of the driveshaft in a rotationally fixed way and, by being axially displaced, can additionally be made to engage the form-fitting elements of the outer joint part, so that a transmission of torque can take place between the driveshaft 4 and the outer joint part 12.

The first and the second form-fitting elements are configured equally, so that the coupling part 44 comprises the same engaging means for engaging the two form-fitting elements. It can be seen that the clutch parts 42, 43 and the form-locking elements respectively comprise an outer diameter D42, D43 that is greater than the pitch circle diameter D14 of the torque transmitting elements 14 of the constant velocity joint 3 and smaller than an inner bearing seat diameter D28 of the joint bearing 28.

The clutch 6 is operated by a controllable actuator 45 which acts on the coupling element 44 for selectively transferring same into the closed position or into the open position. The actuator 45 is an electro-magnetic actuator, i.e., the axial displacement of the coupling element 44 is effected by magnetic forces. It is understood that other actuator types can also be used, for example electro-motive, hydraulic or pneumatic actuators. The actuator 45 comprises an actuator housing 46 which is connected via a flange connection 47 to the clutch housing 3. Furthermore, the actuator 45 comprises an axially movable piston rod 48 whose end remote from the actuator is axially movably received in a bore 49 of the clutch housing 3. A shift-fork 50 is fixed to the piston rod 48, which shift-fork engages an annular groove 52 of the coupling element 44 for transmitting an axial movement of the piston rod 48 to the coupling element 44.

An advantage of the clutch module 2 is that it can be used for many different applications and in different assembly situations within the driveline of a motor vehicle. For example, the clutch module 2 can be connected to a transfer case or a differential gearing in respect of the power path before or behind the gearing.

A possible application for the clutch module 2 is shown in FIG. 5 which will be explained below. FIG. 5 shows an exemplary drive assembly 53 with a differential gearing 54 and an exemplary clutch module 2 according to FIGS. 1 to 4.

The differential gearing 54 comprises a stationary housing 55 in which a differential carrier 56 is rotatably supported around a rotational axis A56 by two bearings 57, 58. For introducing a torque into the differential carrier 56, an annular gear 59 is provided that is firmly connected to the differential carrier, for instance by a welded connection or a threaded connection. In the differential carrier 56, a plurality of differential gears 60 are supported on a journal 62 so as to be rotatable around a journal axis A62. The two differential gears 60 jointly rotate together with the differential carrier 56 and each engage a first and a second output gear 63, 64 that are arranged coaxially relative to the rotational axis A56. The two output gears 63, 64, which can also be referred to as sideshaft gears 63, 64, each comprise splines 65 which are able to engage corresponding outer splines 66 in a driveshaft 4 for transmitting torque. The two output gears 63, 64 are axially supported against the differential carrier 56 by interposed sliding discs 66, 67.

The stationary transmission housing 55 is firmly connected to the clutch housing 3 via a connecting assembly 68. In the present embodiment, the connecting assembly 68 is provided in the form of a flange connection and comprises connecting elements 34 at the clutch housing 3 that are provided in the form of flange portions, furthermore corresponding flange portions 69 at the transmission housing 55 as well as threaded bolts 70 which connect the two flange portions 34, 69 to one another. Between the transmission housing 55 and the clutch housing 3 there is also provided a centering assembly 72 by which the two housings 3, 55 are centered relative to each other. The centering assembly 72 comprises the centering face 10 of the clutch housing 3 and a corresponding centering face 73 at the transmission housing 55, so that the housings 3, 55 are centered relative to one another. The centering faces 10, 73 are formed at the corresponding sleeve-shaped centering portions of the housing 3, 55 and are configured in particular cylindrically. The centering assembly 72 is arranged in particular in an axial overlapping region with the shaft bearing 38, thus achieving an accurate coaxial alignment of the driveshaft 4. For sealing the housing interior, a sealing ring 74 is arranged between the centering faces 10, 73 in an annular groove.

The clutch module 2 according to FIG. 5 largely corresponds to that shown in FIGS. 1 to 4, so that to avoid repetitions, reference is made to the above description. Identical components or components corresponding to one another have been given the same reference numbers as in the embodiment according to FIGS. 1 to 4.

A first difference is that, in the embodiment according to FIG. 5, the connecting elements 34 for providing a connection with the transmission housing 55 are separate from the connecting elements for connecting the two clutch housings 32, 33. A further difference is that the piston rod 48, at its end remote from the actuator 45, is support-free. Furthermore, an annular groove for the sealing ring 74 is provided in the centering face 10 of the clutch housing 3. Otherwise, the clutch module 2 shown in FIG. 5 substantially corresponds to the clutch module 2 shown in FIGS. 1 to 4, so that reference is made to the above description.

An advantage of an exemplary clutch module 2 is that, as a separate, pre-assembled unit, it can be easily connected to a transmission. Thereby, a defined interface with centering elements and connecting elements allows a simple mounting procedure. Furthermore, the clutch module 2 has a compact size so that it is particularly suitable for being used in an axle shaft and/or in a sideshaft of a driving axle.

### LIST OF REFERENCE NUMBERS

2 clutch module
3 clutch housing
4 driveshaft
5 constant velocity joint
6 clutch
7 opening
8 end portion
9 end portion
10 centering face
12 outer joint part
13 inner joint part
14 torque transmitting elements
15 outer ball track
16 inner ball track
17 ball cage
18 opening
19 portion
20 portion
21 cavity
22 driveshaft
23 sealing element
24 tensioning strip
25 tensioning strip
26 shaft bearing
27 supporting bearing
28 joint bearing
29 annular groove
30 bearing
31 joint seal
32 first housing part
33 second housing part
34 connecting element
35 connecting element
36 bearing portion
37 bearing portion
38 bearing seat
39 bearing seat
40 journal
41 gap
42 form-fitting element
43 form-fitting element
44 coupling part
45 actuator
46 actuator housing
47 flange connection
48 piston rod
49 bore
50 shift fork
52 annular groove
53 drive assembly
54 differential gearing
55 transmission housing
56 differential carrier
57 bearing
58 bearing
59 annular gear
60 differential gear
62 journal
63 side shaft gear
64 side shaft gear
65 splines
66 sliding disc
67 sliding disc
68 connecting assembly
69 connecting element
70 threaded bolt
72 centering assembly
73 centering face
74 sealing ring
A rotational axis
D diameter
L length

1.-15. (canceled)

16. A clutch module, for a driveline of a motor vehicle, comprising:
a clutch housing which comprises connecting elements for being connected to a transmission housing;
a driveshaft rotatably supported in the clutch housing around a rotational axis by a shaft bearing, wherein an outer end portion of the driveshaft is positioned outside the clutch housing and an inner end portion of the driveshaft is arranged inside the clutch housing;
a constant velocity joint having an outer joint part, an inner joint part, and torque transmitting elements that are arranged between the outer joint part and the inner joint part for transmitting torque, wherein the outer joint part is at least partially arranged inside the clutch housing and is rotatably supported around the rotational axis by a joint bearing in a joint bearing portion of the clutch housing and comprises a cavity, wherein at least one of the joint bearing portion and of the joint bearing at least partially axially overlaps with the cavity of the outer joint part; and
a controllable clutch that is arranged in the clutch housing and configured to optionally drivingly connect or disconnect the driveshaft and the outer joint part.

17. Clutch module according to claim 16,
wherein the clutch comprises a first clutch part that is connected to the second end portion of the driveshaft, a second clutch part that is connected to the outer joint part, and an axially movable coupling element for drivingly connecting the first clutch part and the second clutch part.

18. Clutch module according to claim 17,
wherein the first clutch part and the second clutch part each comprise a greatest outer diameter that is greater than a pitch circle diameter of the torque transmitting elements of the constant velocity joint.

19. Clutch module according to claim 17,
wherein a greatest head diameter of the second clutch part is smaller than an inner bearing seat diameter of the joint bearing.

20. Clutch module according to claim 17,
wherein the coupling element is configured as a sliding muff that is connected to one of the first and the second clutch parts in a rotationally fixed and axially movable way and, by being axially displaced, can be made to engage the other one of the first and the second clutch part in a rotationally fixed way.

21. Clutch module according to claim 17,
wherein an actuator is provided for displacing the coupling element, wherein the actuator comprises an axially movable piston rod, wherein a shift-fork is provided that is fixed to the piston rod and engages an annular groove of the coupling element for transmitting an axial movement of the piston rod to the coupling element.

22. Clutch element according to claim 21,
wherein the actuator is configured in the form of an electro-magnetic actuator, wherein the displacement of the coupling element is effected by magnetic forces.

23. Clutch module according to claim 16,
wherein the clutch housing comprises a centering face for centering the clutch housing relative to the transmission housing, wherein the centering face is arranged in an axial overlapping region with the shaft bearing.

24. Clutch module according to claim 16,
wherein a smallest opening diameter of the joint bearing portion is greater than a greatest outer diameter of the outer joint part.

25. Clutch module according to claim 16,
wherein the clutch housing comprises a shaft bearing portion in which the shaft bearing is arranged, wherein a smallest opening diameter of the shaft bearing portion is smaller than a greatest outer diameter of the driveshaft.

26. Clutch module according to claim 16,
wherein a radial bearing is provided between the outer joint part and the driveshaft by which the outer joint part and the driveshaft are rotatably supported relative to one another.

27. Clutch module according to claim 16,
wherein a joint sealing ring is sealingly arranged between an outer face of the outer joint part and an inner face of the clutch housing and seals the clutch housing outwardly, wherein the joint sealing ring at least partially axially overlaps with the cavity of the outer joint part.

28. Clutch module according to claim 16,
wherein the greatest axial length of the outer joint part is smaller than the greatest axial length of the driveshaft.

29. A drive assembly with a differential gearing and a clutch module,
wherein the clutch module comprises a clutch housing which comprises connecting elements for being connected to a transmission housing; a driveshaft which is rotatably supported in the clutch housing around a rotational axis by a shaft bearing, wherein an outer end portion of the driveshaft is positioned outside the clutch housing and an inner end portion of the driveshaft is arranged inside the clutch housing; a constant velocity joint having an outer joint part, an inner joint part and torque transmitting elements that are arranged between the outer joint part and the inner joint part for transmitting torque, wherein the outer joint part is at least partially arranged inside the clutch housing and is rotatably supported around the rotational axis by a joint bearing in a joint bearing portion of the clutch housing and comprises a cavity, wherein at least one of the joint bearing portion and of the joint bearing at least partially axially overlaps with the cavity of the outer joint part; and a controllable clutch that is arranged in the clutch housing and configured to optionally drivingly connect or disconnect the driveshaft and the outer joint part;
wherein the differential gearing comprises a transmission housing, a differential carrier that is rotatably supported in the transmission housing around a rotational axis and is rotatingly drivable by a drive gear, and a differential gear set with two output gears,
wherein the clutch housing of the clutch module is connected to the transmission housing of the differential gearing by the connecting elements,
wherein the outer end portion of the driveshaft is connected to one of the two output gears of the differential gearing in a rotationally fixed way.

30. Drive assembly according to claim 29,
wherein the clutch housing and the transmission housing are centered relative to one another by a centering assembly.
